(19) United States
(12) Patent Application Publication
(10) Pub. No.: US 2025/0386862 A1
(43) Pub. Date: Dec. 25, 2025

(54) AEROSOL GENERATING DEVICE

(71) Applicants: KT&G CORPORATION, Daejeon (KR); KOREA ELECTROTECHNOLOGY RESEARCH INSTITUTE, Changwon-si, Gyeongsangnam-do (KR)

(72) Inventors: In Su PARK, Daejeon (KR); Chan Min KWON, Daejeon (KR); Tae Kyun KIM, Daejeon (KR); Mi Jeong LEE, Daejeon (KR); John Tae LEE, Daejeon (KR); Tae Kyung LEE, Daejeon (KR); Dae Ho KIM, Changwon-si, Gyeongsangnam-do (KR); Ji Won SHIN, Changwon-si, Gyeongsangnam-do (KR)

(73) Assignees: KT&G CORPORATION, Daejeon (KR); KOREA ELECTROTECHNOLOGY RESEARCH INSTITUTE, Changwon-si, Gyeongsangnam-do (KR)

(21) Appl. No.: 18/881,358

(22) PCT Filed: Aug. 31, 2023
(86) PCT No.: PCT/KR2023/013036

§ 371 Date: Jan. 6, 2025

(30) Foreign Application Priority Data
Aug. 31, 2022 (KR) 10-2022-0110268
Aug. 30, 2023 (KR) 10-2023-0114651

(51) Int. Cl. A24F 40/46; A24F 40/53; A24F 40/57; H05B 6/68; H05B 6/80

(52) U.S. Cl. CPC A24F 40/46; A24F 40/53; A24F 40/57; H05B 6/68; H05B 6/686; H05B 6/80

(57) ABSTRACT

An aerosol generating device includes an oscillating unit configured to generate microwaves, a resonating unit configured to accommodate an aerosol generating article and heat the aerosol generating article by resonating the microwaves, a power monitoring unit configured to measure reflected microwave power that is reflected from the resonating unit and input to the oscillating unit, and a processor configured to control the output of the oscillating unit based on the reflected microwave power measured by the power monitoring unit.

### TECHNICAL FIELD

One or more embodiments relate to an aerosol generating device for heating an aerosol generating article by using a dielectric heating method, and more particularly, to an aerosol generating device capable of tracking in real time a change in a resonance frequency according to depletion of a dielectric material included in the aerosol generating article.

### BACKGROUND ART

Recently, the demand for alternative methods for overcoming the shortcomings of general cigarettes has increased. For example, there is an increasing demand for a system for generating aerosols by heating a cigarette (or an ‘aerosol generating article’) by using an aerosol generating device, rather than by burning cigarettes.

Existing aerosol generating devices heat aerosol generating materials by using a resistance heating method, an induction heating method, or an ultrasonic heating method. However, compared to aerosol generating devices employing dielectric heating, the preheating speed of the existing aerosol generating devices is low and aerosol generating articles in such devices are not uniformly heated.

Additionally, some of the existing aerosol generating devices use a dielectric heating method, which is merely a microwave radiation method using antennas. Thus, the power transmission efficiency of the existing aerosol generating devices is very low. Disclosure

### TECHNICAL PROBLEM

One or more embodiments provide an aerosol generating device capable of heating an aerosol generating article by using a dielectric heating method utilizing microwave resonance to overcome the aforementioned problems.

The technical problems of the disclosure are not limited to the aforementioned description, and other technical problems may be derived from the embodiments described hereinafter.

### TECHNICAL SOLUTION

According to an embodiment, an aerosol generating device includes an oscillating unit configured to generate microwaves, a resonating unit configured to accommodate an aerosol generating article and heat the aerosol generating article by resonating the microwaves, a power monitoring unit configured to measure reflected microwave power that is reflected from the resonating unit and input to the oscillating unit, and a processor configured to control the output of the oscillating unit based on the reflected microwave power that is measured by the power monitoring unit.

### ADVANTAGEOUS EFFECTS

Because an aerosol generating device according to one or more embodiments of the disclosure heats a dielectric material through microwave resonance, power transmission efficiency may significantly increase.

In addition, because the aerosol generating device tracks a resonance frequency of microwave resonance in real time and matches an output frequency of an oscillating unit with the resonance frequency, power transmission efficiency may greatly increase, and a uniform smoking sensation may be provided even during the later stages of heating.

Moreover, because the aerosol generating device heats an aerosol generating article through microwave resonance, the aerosol generating article may be evenly heated throughout.

Also, because the aerosol generating device heats the aerosol generating article through microwave resonance, the aerosol generating article may be quickly heated.

Furthermore, when the aerosol generating device heats the aerosol generating article through microwave resonance, power consumption may greatly decrease.

Effects of the disclosure are not limited to those stated above, and a variety of additional effects are included in the specification.

### DESCRIPTION OF DRAWINGS

FIG. 1 is a perspective view of an aerosol generating device according to an embodiment.

FIG. 2 is an internal block diagram of an aerosol generating device according to an embodiment.

FIG. 3 is an internal block diagram of a dielectric heating unit of FIG. 2.

FIG. 4 is a perspective view of a heater assembly according to an embodiment.

FIG. 5 is a cross-sectional view of the heater assembly of FIG. 4.

FIG. 6 is a schematic perspective view of a heater assembly according to another embodiment.

FIG. 7 is an internal block diagram for explaining an output control method of an oscillating unit, according to an embodiment.

FIG. 8 is a diagram showing a method of tracking a resonance frequency by using output microwave power of an oscillating unit and reflected microwave power of a resonating unit.

FIG. 9 is a flowchart of an operating method of an aerosol generating device according to an embodiment.

### BEST MODE

According to an embodiment, aerosol generating device includes an oscillating unit configured to generate microwaves, a resonating unit configured to accommodate an aerosol generating article and heat the aerosol generating article by resonating the microwaves, a power monitoring unit configured to measure reflected microwave power that is reflected from the resonating unit and input to the oscillating unit, and a processor configured to control the output of the oscillating unit based on the reflected microwave power that is measured by the power monitoring unit.

In the resonating unit, a resonance frequency of the microwaves may vary as a dielectric material in the aerosol generating article is heated by the microwaves and consumed.

A resonance frequency of the resonating unit may increase as the dielectric material in the aerosol generating article is consumed.

The power monitoring unit may be further configured to measure the reflected microwave power corresponding to a change in the resonance frequency.

The processor may be further configured to control an output of the oscillating unit so that the reflected microwave measured by the power monitoring unit is included in a preset reference power range.

The processor may be further configured to sweep the output frequency of the microwave power output from the oscillating unit within the preset reference frequency range and adjust the output frequency of the microwave power so that the reflected microwave power is included in the reference power range.

The processor may be further configured to sweep the output frequency of the microwave power output from the oscillating unit within the reference frequency range from about 2.4 Ghz to about 2.5 Ghz.

The processor may be further configured to match the output frequency with a resonance frequency of the resonating unit by adjusting the output frequency of the microwave power with any one frequency selected from the reference frequency range.

The processor may be further configured to adjust a magnitude of microwave power that is output from the oscillating unit and independently control the magnitude of the microwave power and the output frequency of the microwave power according to a preset power profile.

The resonating unit may include a first internal conductor with a hollow cylinder shape surrounding a portion of the aerosol generating article and a second internal conductor arranged apart from the first internal conductor by a certain distance and having a hollow cylinder shape surrounding another portion of the aerosol generating article, and the microwaves may resonate between the first internal conductor and the second internal conductor.

The resonating unit may include a first plate surrounding a portion of the aerosol generating article and a second plate spaced apart from the first plate along a circumferential direction of the aerosol generating article and surrounding another portion of the aerosol generating article, and the microwaves may resonate between the first plate and the second plate.

### Mode for Invention

Hereinafter, embodiments disclosed in this specification will be described in detail with reference to the accompanying drawings, and identical or similar components will be assigned the same reference numbers, regardless of the drawing symbols, and redundant explanations will be omitted.

The suffixes “module” and “unit” used in this description are assigned or used interchangeably solely for the convenience of drafting the specification and do not themselves have distinct meanings or roles.

Also, in describing the embodiments disclosed in this specification, detailed descriptions of well-known technologies may be omitted if it is determined that they could obscure the essence of the embodiments disclosed herein. Additionally, the accompanying drawings are provided merely to facilitate the understanding of the embodiments disclosed in this specification, and the technical spirit disclosed herein is not limited by the drawings. It should be understood that all modifications, equivalents, and substitutes that fall within the spirit and scope of this disclosure are included.

Terms including ordinal numbers, such as first, second, etc., may be used to describe various components, but the components are not limited by the terms. The above terms are used solely to distinguish one component from another.

When a component is referred to as being “connected” or “coupled” to another component, it should be understood that the component may be directly connected or coupled to the other component, or there may be intervening components in between. On the other hand, when a component is referred to as being “directly connected” or “directly coupled” to another component, it should be understood that there are no intervening components in between.

Singular expressions include plural expressions unless the context clearly indicates otherwise.

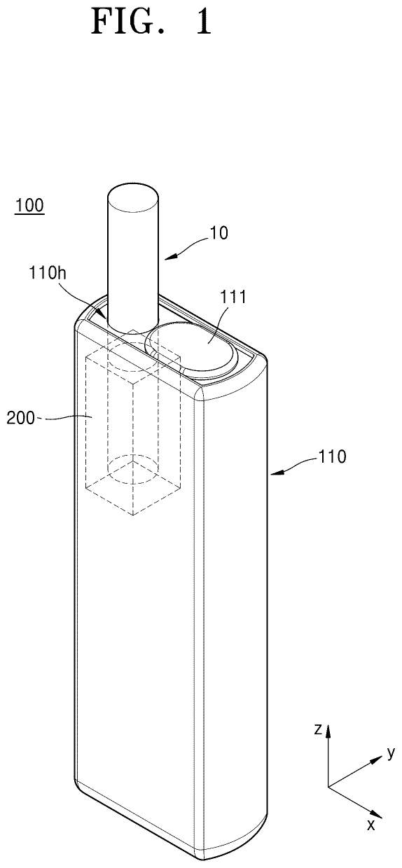

FIG. 1 is a perspective view of an aerosol generating device according to an embodiment.

Referring to FIG. 1, an aerosol generating device 100 according to an embodiment may include a housing 110 for accommodating an aerosol generating article 10 and a heater assembly 200 for heating the aerosol generating article 10 accommodated in the housing 110.

The housing 110 may form the overall exterior of the aerosol generating device 100, and components of the aerosol generating device 100 may be arranged in an inner space (or a ‘mounting space’) of the housing 110. For example, the heater assembly 200, a battery, a processor, and/or a sensor may be arranged in the inner space of the housing 110, but the components arranged in the inner space are not limited thereto.

An insertion hole 110h may be formed in a portion of the housing 110, and at least a portion of the aerosol generating article 10 may be inserted into the housing 110 through the insertion hole 110h. For example, the insertion hole 110h may be formed in a portion of an upper surface (e.g., a surface in a z direction) of the housing 110, but the position of the insertion hole 110h is not limited thereto. In another embodiment, the insertion hole 110h may be formed in a portion of a side surface (e.g., a surface in an x direction) of the housing 110.

The heater assembly 200 may be arranged in the inner space of the housing 110 and heat the aerosol generating article 10 inserted into or accommodated in the housing 110 through the insertion hole 110h. For example, the heater assembly 200 may be positioned to surround at least a portion of the aerosol generating article 10 inserted into or accommodated in the housing 110, thus heating the aerosol generating article 10.

According to an embodiment, the heater assembly 200 may heat the aerosol generating article 10 by using a dielectric heating method. In the present specification, the term ‘dielectric heating method’ refers to a method of heating a dielectric material, which is a heating object, by using resonance of microwaves and/or an electric field (which may include a magnetic field) of the microwaves. Microwaves are energy sources used to heat a heating object and are generated by high-frequency power, and thus, the term ‘microwave’ may hereinafter be used interchangeably with microwave power.

Charges or ions in a dielectric material included in the aerosol generating article 10 may vibrate or rotate because of microwave resonance within the heater assembly 200, and frictional heat generated during the vibration or rotation of the charges or ions may cause heat to be generated from the dielectric material such that the aerosol generating article 10 may be heated.

As the aerosol generating article 10 is heated by the heater assembly 200, an aerosol may be generated from the aerosol generating article 10. In the present specification, the term ‘aerosol’ may refer to gaseous particles generated from a mixture of vapor and air that are produced as the aerosol generating article 10 is heated.

The aerosol generated from the aerosol generating article 10 may pass through the aerosol generating article 10 or may be discharged to the outside of the aerosol generating device 100 through an empty space between the aerosol generating article 10 and the insertion hole 110h. A user may place their mouth on a portion of the aerosol generating article 10 exposed to the outside of the housing 110 and may inhale the aerosol discharged from the aerosol generating device 100, thereby smoking.

The aerosol generating device 100 according to an embodiment may further include a cover 111 that is movably arranged on the housing 110 to open or close the insertion hole 110h. For example, the cover 111 may be slidably coupled to the upper surface of the housing 110 and may expose the insertion hole 110h to the outside of the aerosol generating device 100 or cover the insertion hole 110h to prevent the same from being exposed to the outside of the aerosol generating device 100.

In an embodiment, the cover 111 may allow the insertion hole 110h to be exposed to the outside of the aerosol generating device 100 at a first position (or ‘open position’). When the aerosol generating device 100 is externally exposed, the aerosol generating article 10 may be inserted into the housing 110 through the insertion hole 110h.

In another embodiment, the cover 111 covers the insertion hole 110h at a second position (or ‘closed position’) to prevent the insertion hole 110h from being exposed outside the aerosol generating device 100. In this case, the cover 111 may prevent external foreign materials from entering the heater assembly 200 through the insertion hole 110h when the aerosol generating device 100 is not in use.

FIG. 1 only shows the aerosol generating device 100 for heating the aerosol generating article 10 in a solid state, but the aerosol generating device 100 is not limited thereto.

An aerosol generating device according to another embodiment may generate an aerosol by heating an aerosol generating material in a liquid or gel state by using the heater assembly 200, rather than heating the aerosol generating article 10 in a solid state.

An aerosol generating device according to another embodiment may include a heater assembly 200 that heats an aerosol generating article 10 and a cartridge (or ‘vaporizer’) that contains an aerosol generating material in a liquid or gel state and heats the same. After moving to the aerosol generating article 10 along an airflow passage connecting the cartridge and the aerosol generating article 10, the aerosol generated from the aerosol generating material may be mixed with the aerosol produced by the aerosol generating article 10 and then delivered to the user via the aerosol generating article 10.

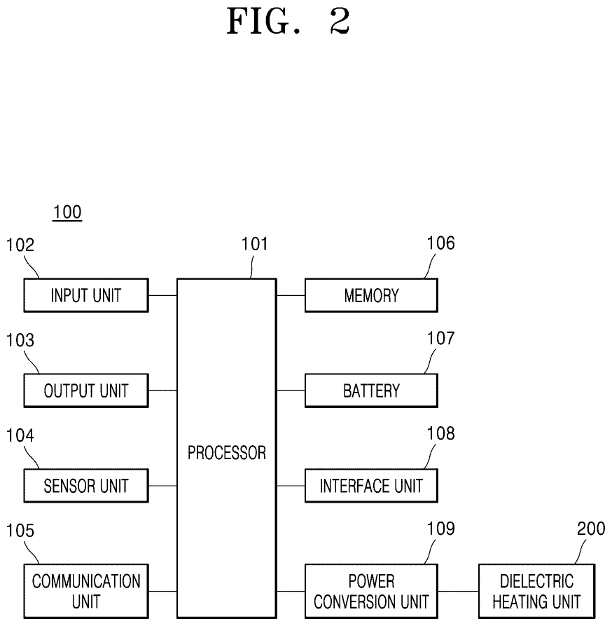

FIG. 2 is an internal block diagram of an aerosol generating device according to an embodiment.

Referring to FIG. 2, the aerosol generating device 100 may include an input unit 102, an output unit 103, a sensor unit 104, a communication unit 105, a memory 106, a battery 107, an interface unit 108, a power converter 109, and a dielectric heating unit 200.

The input unit 102 may receive a user input. For example, the input unit 102 may be a single pressure-type push button. As another example, the input unit 102 may be a touch panel including at least one touch sensor. The input unit 102 may transmit an input signal to a processor 101. The processor 101 may supply power to the dielectric heating unit 200 based on a user input or control the output unit 103 to output a user notification.

The output unit 103 may output information on a state of the aerosol generating device 100. The output unit 103 may output a charge/discharge state of the battery 107, a heating state of the dielectric heating unit 200, an insertion state of the aerosol generating article 10, and error information of the aerosol generating device 100. To this end, the output unit 103 may include a display, a haptic motor, and a sound output unit.

The sensor unit 104 may sense a state of the aerosol generating device 100 and a state around the aerosol generating device 100 and may transmit sensed information to the processor 101. Based on the sensed information, the processor 101 may control the aerosol generating device 100 to perform various functions, such as heating control of the dielectric heating unit 200, limiting smoking, determining whether the aerosol generating article 10 is inserted, and displaying a notification.

The sensor unit 104 may include a temperature sensor, a puff sensor, and an insertion detection sensor.

The temperature sensor may sense an internal temperature of the dielectric heating unit 200 in a non-contact manner or may contact the dielectric heating unit 200 to thus directly obtain a temperature of a resonator. According to an embodiment, the temperature sensor may also sense the temperature of the aerosol generating article 10. In addition, the temperature sensor may be arranged adjacent to the battery 107 and obtain the temperature thereof. The processor 101 may control the power supplied to the dielectric heating unit 200, based on temperature information of the temperature sensor.

The puff sensor may detect a user's puff. The puff sensor may sense a user's puff on the basis of at least one of a temperature change, a flow change, a power change, and a pressure change. The processor 101 may control the power supplied to the dielectric heating unit 200, based on puff information from the puff sensor. For example, the processor 101 may count the number of puffs, and when the number of puffs reaches a preset maximum number of puffs, the processor 101 may block the power supplied to the dielectric heating unit 200. As another example, the processor 101 may block the power supplied to the dielectric heating unit 200 when no puffs are sensed for a certain period of time.

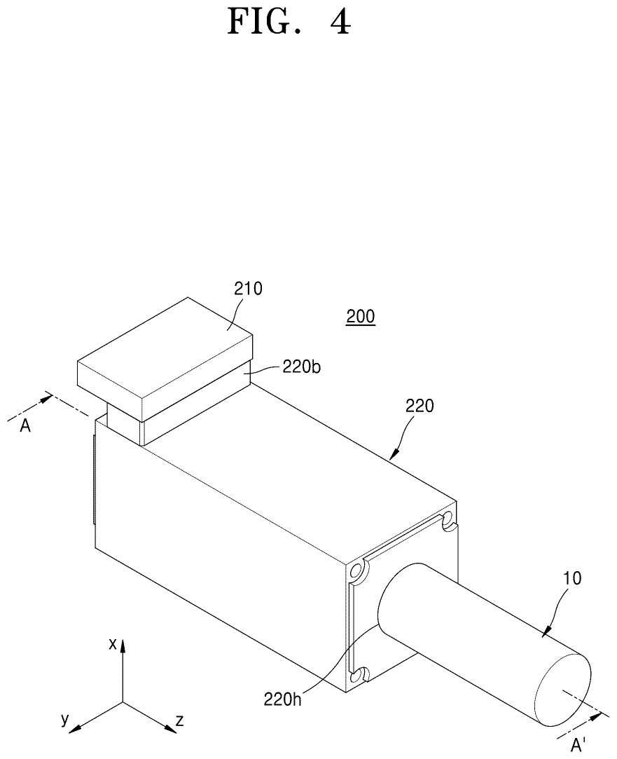

The insertion detection sensor may be arranged inside or adjacent to an accommodation space (220h of FIG. 4) and thus may detect the insertion and removal of the aerosol generating article 10 accommodated in the insertion hole 110h. For example, the insertion detection sensor may include an inductive sensor and/or a capacitance sensor. When the aerosol generating article 10 is inserted into the insertion hole 110h, the processor 101 may supply power to the dielectric heating unit 200.

According to an embodiment, the sensor unit 104 may additionally include a reuse detection sensor, a motion detection sensor, a humidity sensor, a barometric pressure sensor, a magnetic sensor, a cover detachment detection sensor, a location sensor (a global positioning system (GPS)), a proximity sensor, and the like. Because a function of each of sensors may be intuitively inferred from the name of the sensor, a detailed description thereof may be omitted.

The communication unit 105 may include at least one communication module for communication with external electronic device. The processor 101 may control the communication unit 105 and transmit information regarding the aerosol generating device 100 to the external electronic device. Alternatively, the processor 101 may receive information from the external electronic device through the communication unit 105 and control the components included in the aerosol generating device 100. For example, information exchanged between the communication unit 105 and the external electronic device may include user authentication information, firmware update information, and user's smoking pattern information.

The memory 106 may be a hardware component that stores various types of data processed in the aerosol generating device 100 and may store data processed and data to be processed by the processor 101. For example, the memory 106 may store an operation time of the aerosol generating device 100, the maximum number of puffs, the current number of puffs, at least one temperature profile, data on a user's smoking pattern, etc.

The battery 107 may supply power to the dielectric heating unit 200 to heat the aerosol generating article 10. In addition, the battery 107 may supply power required for operations of other components included in the aerosol generating device 100. The battery 110 may be a rechargeable battery or a separable and detachable battery.

The interface unit 108 may include a connection terminal that may be physically connected to the external electronic device. The connection terminal may include at least one of a High-Definition Multimedia Interface (HDMI) connector, a Universal Serial Bus (USB) connector, a Secure Digital (SD) card connector, and an audio connector (e.g., a headphone connector) or a combination thereof. The interface unit 108 may exchange information with the external electronic device through the connection terminal or charge power.

The power converter 109 may convert direct current power from the battery 107 into alternating current power. In addition, the power converter 109 may supply the converted alternating current power to the dielectric heating unit 200. The power converter 109 may be an inverter including at least one switching device, and the processor 101 may control the ON/OFF state of the switching device included in the power converter 109 and convert direct current power into alternating current power. The power converter 109 may be implemented as a full bridge or a half bridge.

The dielectric heating unit 200 may heat the aerosol generating article 10 by using a dielectric heating method. The dielectric heating unit 200 may correspond to the heater assembly 200 of FIG. 1.

The dielectric heating unit 200 may use microwaves and/or an electric field of microwaves (hereinafter, referred to as microwaves or microwave power when no classification is required) to heat the aerosol generating article 10. The heating method of the dielectric heating unit 200 may include heating a heating object by producing microwaves in a resonance structure, rather than radiating microwaves by using an antenna. The resonance structure is described below with reference to FIGS. 4 and subsequent figures.

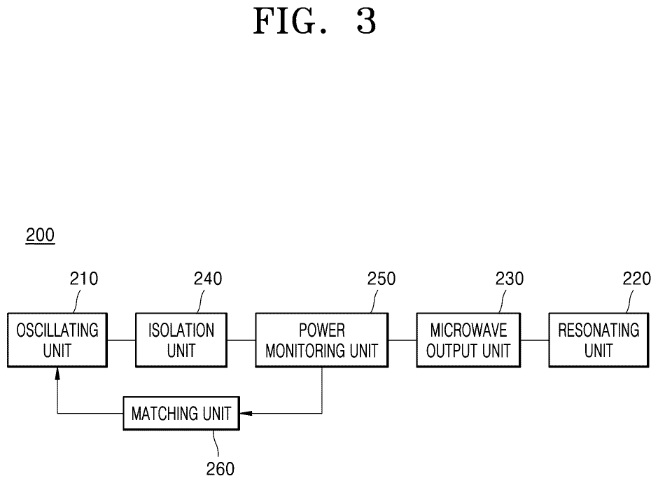

The dielectric heating unit 200 may output high-frequency microwaves to a resonating unit (220 of FIG. 3). Microwaves may be power in an Industrial Scientific and Medical (ISM) band allowed for heating, but one or more embodiments are not limited thereto. The resonating unit 220 may be designed by taking the wavelength of the microwaves into account to facilitate the resonance of the microwaves within the resonating unit 220.

The aerosol generating article 10 may be inserted into the resonating unit 220, and a dielectric material in the aerosol generating article 10 may be heated by the resonating unit 220. For example, the aerosol generating article 10 may include a polar substance, and molecules in the polar substance may be polarized in the resonating unit 220. The molecules may vibrate or rotate due to polarization, and the aerosol generating article 10 may be heated by frictional heat generated during the vibration or rotation. The dielectric heating unit 200 is described in more detail with reference to FIG. 3.

The processor 101 may control general operations of the aerosol generating device 100. The processor 101 may be implemented as an array of a plurality of logic gates or as a combination of a general-purpose microprocessor and a memory in which a program executable in the microprocessor is stored. Also, the processor 101 may be implemented in other forms of hardware.

The processor 101 may control direct current power supplied from the battery 107 to the power converter 109 and/or alternating current power supplied from the power converter 109 to the dielectric heating unit 200, according to power required for the dielectric heating unit 200. In an embodiment, the aerosol generating device 100 may include a converter that increases or decreases direct current power, and the processor 101 may control the converter to adjust the magnitude of the direct current power. Additionally, the processor 101 may adjust a switching frequency and a duty ratio of the switching device included in the power converter 109, thus controlling the alternating current power supplied to the dielectric heating unit 200.

The processor 101 may control microwave power of the dielectric heating unit 200 and a resonance frequency of the dielectric heating unit 200, thereby controlling a heating temperature of the aerosol generating article 10. Therefore, an oscillating unit 210, an isolation unit 240, a power monitoring unit 250, and a matching unit 260 of FIG. 3 described below may be some components of the processor 101.

The processor 101 may control microwave power of the dielectric heating unit 200 based on temperature profile information stored in the memory 106. In other words, a temperature profile may include information regarding a target temperature of the dielectric heating unit 200 over time, and the processor 101 may control the microwave power of the dielectric heating unit 200 over time.

The processor 101 may adjust the frequency of the microwaves to make the resonance frequency of the dielectric heating unit 200 uniform. The processor 101 may track a change in the resonance frequency of the dielectric heating unit 200 in real time as the heating object is heated, and may control the dielectric heating unit 200 to output a microwave frequency according to the changing resonance frequency. In other words, the processor 101 may adjust the microwave frequency in real time, irrespective of the temperature profile stored in advance.

FIG. 3 is an internal block diagram of the dielectric heating unit of FIG. 2.

Referring to FIG. 3, the dielectric heating unit 200 may include the oscillating unit 210, the isolation unit 240, the power monitoring unit 250, the matching unit 260, a microwave output unit 230, and the resonating unit 220.

The oscillating unit 210 may receive alternating current power from the power converter 109 and generate high-frequency microwave power. According to an embodiment, the power converter 109 may be included in the oscillating unit 210. Microwave power may be selected from the frequency bands, such as 915 MHz, 2.45 GHz, and 5.8 GHz, which are included in the ISM bands.

The oscillating unit 210 may include a solid-state-based RF generating device and generate microwave power by using the same. The solid-state-based RF generating device may be realized as a semiconductor. When the oscillating unit 210 is implemented as a semiconductor, the dielectric heating unit 200 may be miniaturized, and the lifespan of the device may be extended.

The oscillating unit 210 may output microwave power to the resonating unit 220. The oscillating unit 210 may include a power amplifier that increases or decreases the microwave power, and the power amplifier may adjust the magnitude of the microwave power under the control by the processor 101. For example, the power amplifier may decrease or increase the amplitude of microwaves. As the amplitude of microwaves is adjusted, the microwave power may also be adjusted.

The processor 101 may adjust the magnitude of the microwave power output from the oscillating unit 210, based on the temperature profile stored in advance. For example, the temperature profile may include target temperature information according to the preheating section and the smoking section, and the oscillating unit 210 may supply microwave power at a first power level in the preheating section and supply microwave power at a second power level in the smoking section, wherein the second power level is less than the first power level.

The isolation unit 240 may block the microwave power that is input to the oscillating unit 210 from the resonating unit 220. Most of the microwave power that is output from the oscillating unit 210 is absorbed into the heating object, but depending on the heating characteristics of the heating object, part of the microwave power may be reflected from the heating object and transmitted back towards the oscillating unit 210. This occurs due to a change in the impedance measured from the oscillating unit 210 to the resonating unit 220 as polar molecules are depleted while the heating object is heated. The description that ‘the impedance from the oscillating unit 210 to the resonating unit 220 changes’ may be the same as the description that ‘the resonance frequency of the resonating unit 220 changes.’ When the microwave power reflected from the resonating unit 220 is input to the oscillating unit 210, the oscillating unit 210 may not only malfunction but also fail to achieve expected output performance. The isolation unit 240 may not redirect the microwave power, which is reflected from the resonating unit 220, to the oscillating unit 210 and may guide the microwave power in a certain direction to absorb the same. To this end, the isolation unit 240 may include a circulator and a dummy load.

The power monitoring unit 250 may monitor the microwave power, which is output from the oscillating unit 210, and the reflected microwave power, which is reflected from the resonating unit 220, respectively. The power monitoring unit 250 may transmit information regarding the microwave power and the reflected microwave power to the matching unit 260.

The matching unit 260 may match the impedance measured from the oscillating unit 210 to the resonating unit 220 with the impedance measured from the resonating unit 220 to the oscillating unit 210 to minimize the reflected microwave power. Impedance matching may indicate that the frequency of the oscillating unit 210 aligns with the resonance frequency of the resonating unit 220. Therefore, the matching unit 260 may vary the frequency of the oscillating unit 210 to match the impedance. In other words, the matching unit 260 may adjust the frequency of the microwave power that is output from the oscillating unit 210 to minimize the reflected microwave power. The impedance matching by the matching unit 260 may be performed in real time regardless of the temperature profile.

The oscillating unit 210, the isolation unit 240, the power monitoring unit 250, and the matching unit 260 described above may be distinct from the microwave output unit 230 and the resonating unit 220 below and may be implemented as microwave sources in the form of chips. According to an embodiment, the oscillating unit 210, the isolation unit 240, the power monitoring unit 250, and the matching unit 260 may be implemented as some components of the processor 101.

The microwave output unit 230 may be a component configured to input the microwave power to the resonating unit 220 and may correspond to a coupler shown in FIG. 3 and subsequent figures. The microwave output unit 230 may be implemented in the form of SubMiniature version A (SMA), SubMiniature version B (SMB), Micro Coaxial (MCX), and Micro-Miniature coaxial (MMCX) connectors. The microwave output unit 230 may connect the resonating unit 220 to a chip-shaped microwave source and deliver microwave power generated from the microwave source to the resonating unit 220.

The resonating unit 220 may form microwaves within the resonance structure, thus heating the heating object. The resonating unit 220 may include an accommodation space where the aerosol generating article 10 is accommodated, and the aerosol generating article 10 may be exposed to microwaves and dielectric-heated. For example, the aerosol generating article 10 may include a polar substance, and molecules in the polar substance may be polarized by the microwaves within the resonating unit 220. The molecules may vibrate or rotate due to polarization, and the aerosol generating article 10 may be heated by frictional heat generated during the vibration or rotation.

The resonating unit 220 may include at least one internal conductor to resonate microwaves, and depending on the arrangement, thickness, length, and the like of the internal conductor, the microwaves may resonate within the resonating unit 220.

The resonating unit 220 may be designed by taking the wavelength of the microwaves into account to facilitate the resonance of the microwaves within the resonating unit 220. For the resonance of the microwaves within the resonating unit 220, there is a need for a closed end/short end with a closed cross-section and an open end with at least one open portion on the opposite side. In addition, the length between the closed end/short end and the open end must be set to an integer multiple of ¼ of the microwave wavelength. The resonating unit 220 selects a length equal to ¼ of the microwave wavelength to ensure device miniaturization. In other words, the length between the closed end/short end and the open end of the resonating unit 220 may be set to ¼ of the microwave wavelength.

The resonating unit 220 may include a dielectric accommodation space. The dielectric accommodation space is separate from the accommodation space of the aerosol generating article 10 and contains a material that may reduce the size of the resonating unit 220 by changing the overall resonance frequency of the resonating unit 220. In an embodiment, dielectric materials with low microwave absorption may be accommodated in the dielectric accommodation space. Such accommodation is intended to prevent energy, which should be delivered to the heating object, from being transferred to the dielectric materials and causing the dielectric materials to generate heat. Microwave absorbance may be expressed as a loss tangent that is a ratio of a real part of a complex dielectric constant to an imaginary part thereof. In an embodiment, dielectric materials with a loss tangent of a preset value or less may be accommodated in the dielectric accommodation space 227, and the preset value may be 1/100. For example, the dielectric material may include at least any one of quartz, tetrafluoroethylene, and aluminum oxide, or a combination thereof, but one or more embodiments are not limited thereto.

FIG. 4 is a perspective view of a heater assembly according to an embodiment.

Referring to FIG. 4, the heater assembly 200 according to an embodiment may include the oscillating unit 210 and the resonating unit 220. FIG. 4 may show an embodiment of the heater assembly 200 and the dielectric heating unit 200 described above, and repeated description is omitted.

The oscillating unit 210 may generate microwaves in a designated frequency band as power is supplied. The microwaves generated by the oscillating unit 210 may be transferred to the resonating unit 220 through a coupler (not shown).

The resonating unit 220 may include the accommodation space 220h for accommodating at least a portion of the aerosol generating article 10 and resonate the microwaves generated by the oscillating unit 210, thus heating the aerosol generating article 10 by using the dielectric heating method. For example, charges of glycerin included in the aerosol generating article 10 may vibrate or rotate due to the resonance of the microwaves, and frictional heat generated during such vibration or rotation may cause heat to be produced in the glycerin such that aerosol generating article 10 may be heated.

According to an embodiment, the resonating unit 220 may include a material with low microwave absorption to prevent the microwaves, generated by the oscillating unit 210, from being absorbed into the resonating unit 220.

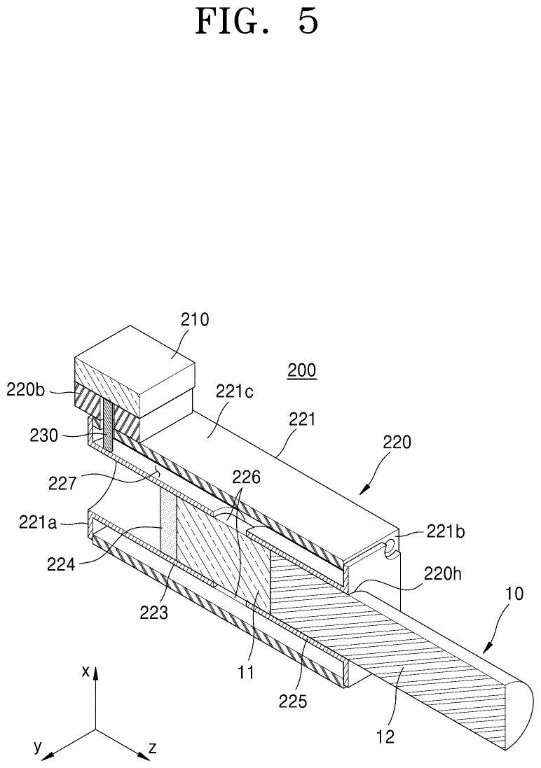

Hereinafter, the detailed structure of the resonating unit 220 of the heater assembly 200 is described with reference to FIG. 5.

FIG. 5 is a cross-sectional view of the heater assembly of FIG. 4. FIG. 5 shows a cross-section of the heater assembly 200 of FIG. 4, taken along a direction A-A′.

Referring to FIG. 5, the heater assembly 200 according to an embodiment may include the oscillating unit 210, the resonating unit 220, and a coupler 230. The components of the heater assembly 200 may be the same as or similar to at least one of the components of the heater assembly 200 of FIG. 4, and repeated description is omitted hereinafter.

The oscillating unit 210 may generate microwaves in a designated frequency band as an alternating current voltage is applied, and the microwaves generated by the oscillating unit 210 may be delivered to the resonating unit 220 through the coupler 230.

According to an embodiment, the oscillating unit 210 may be fixed to the resonating unit 220 to prevent separation from the resonating unit 220 while the aerosol generating device is used. In an embodiment, the oscillating unit 210 may be supported by brackets 220b protruding along the x direction on a portion of the resonating unit 220, thus being fixed to the resonating unit 220. In another embodiment, the oscillating unit 210 may be fixed to a portion of the resonating unit 220 without the brackets 220b.

In the drawing, the oscillating unit 210 is fixed to a portion of the resonating unit 220 that faces the x direction, but the position of the oscillating unit 210 is not limited thereto. In another embodiment, the oscillating unit 210 may be fixed to another portion of the resonating unit 220 that faces in the-z direction.

The resonating unit 220 may be arranged to surround at least a portion of the aerosol generating article 10 inserted into the aerosol generating device and may heat the aerosol generating article 10 by using the microwaves generated by the oscillating unit 210. For example, dielectric materials included in the aerosol generating article 10 may generate heat because of the electric field generated in the resonating unit 220 due to the microwaves, and the aerosol generating article 10 may be heated by the heat generated in the dielectric materials.

According to an embodiment, the aerosol generating article 10 may include a tobacco rod 11 and a filter rod 12.

The tobacco rod 11 may include an aerosol generating material and may be formed as a sheet, a strand, or a pipe tobacco formed of tiny bits cut from a tobacco sheet. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 11 may include other additives, such as flavors, a wetting agent, and/or organic acid. Also, the tobacco rod 11 may include a flavored liquid, such as menthol or a moisturizer, which is injected to the tobacco rod 11.

The filter rod 12 may include a cellulose acetate filter. Shapes of the filter rod 12 are not limited. For example, the filter rod 12 may include a cylinder-type rod or a tube-type rod having a hollow inside. Also, the filter rod 12 may include a recess-type rod. When the filter rod 12 includes a plurality of segments, at least one of the plurality of segments may have a different shape.

At least part (e.g., glycerin) of the aerosol generating material included in the aerosol generating article 10 may be a dielectric material with polarity in an electric field, and the at least part of the aerosol generating material may generate heat in a dielectric heating method, thereby heating the aerosol generating article 10.

According to an embodiment, the resonating unit 220 may include an outer conductor 221, a first internal conductor 223, and a second internal conductor 225.

The outer conductor 221 may form the overall exterior of the resonating unit 220 and have a shape with a hollow space therein; thus, the components of the resonating unit 220 may be arranged inside the outer conductor 221. The outer conductor 221 may include the accommodation space 220h where the aerosol generating article 10 may be accommodated, and the aerosol generating article 10 may be inserted into the outer conductor 221 through the accommodation space 220h.

According to an embodiment, the outer conductor 221 may include a first surface 221a, a second surface 221b facing the first surface 221a, and side surfaces 221c surrounding an empty space between the first surface 221a and the second surface 221b. At least a portion (e.g., the first internal conductor 223 and the second internal conductor 225) of the components of the resonating unit 220 may be arranged in the inner space of the resonating unit 220 formed by the first surface 221a, the second surface 221b, and the side surfaces 221c.

The first internal conductor 223 may be shaped as a hollow cylinder extending in a direction towards the inner space of the outer conductor 221 from the first surface 221a of the outer conductor 221.

According to an embodiment, a portion of the first internal conductor 223 may contact the coupler 230 connected to the oscillating unit 210, and the microwaves generated by the oscillating unit 210 may be transferred to the first internal conductor 223 through the coupler 230. For example, the coupler 230 may penetrate the outer conductor 221 and may be arranged so that one end of the coupler 230 contacts the oscillating unit 210 and the other end contacts a portion of the first internal conductor 223, and the microwaves generated by the oscillating unit 210 may be transferred to the first internal conductor 223 through the coupler 230.

In this case, the coupler 230 may be arranged not to contact the outer conductor 221 but to penetrate the same to transfer the microwaves, but the arrangement of the coupler 230 is not limited thereto as long as the microwaves generated by the oscillating unit 210 may be delivered to the first internal conductor 223.

A first area formed between the outer conductor 221 and the first internal conductor 223 may function as a ‘first resonator’ that generates an electric field through microwave resonance. The first area may refer to the space formed by the first surface 221a and the side surfaces 221c of the outer conductor 221 and the first internal conductor 223, and within the first area, an electric field may be generated as the microwaves transmitted through the coupler 230 resonate.

The second internal conductor 225 may be shaped as a hollow cylinder extending in a direction towards the inner space of the outer conductor 221 from the second surface 221b of the outer conductor 221. The second internal conductor 225 may be spaced apart from the first internal conductor 223 by a certain distance within the inner space of the outer conductor 221, and there may be a gap between the first internal conductor 223 and the second internal conductor 225.

A second area formed between the outer conductor 221 and the second internal conductor 225 may function as a ‘second resonator’ that generates an electric field through microwave resonance. The second internal conductor 225 may be coupled to the first internal conductor 223 (e.g., capacitive coupling), and when an electric field is generated in the first area because of the above coupling relationship, an induced electric field may be generated even in the second area. In the present specification, the term ‘capacitive coupling’ may refer to a coupling relationship in which energy may be transferred due to capacitance between two conductors.

For example, as the microwaves generated by the oscillating unit 210 are delivered to the first internal conductor 223, an electric field may be generated in the first area due to resonance, and an induced electric field may be generated in the second area that is formed by the second internal conductor 225 coupled to the outer conductor 221 and the first internal conductor 223.

According to an embodiment, the first area and the second area of the resonating unit 220 may operate as resonators with a length equal to a quarter of the microwave wavelength λ.

In an embodiment, one end of the first area (e.g., an end in the-z direction) may be formed as a closed end/short end as the cross-section of the first area is closed by the first surface 221a of the outer conductor 221, and the other end of the first area (e.g., an end in the z direction) may be formed as an open end because the first surface 221a is not present, leaving the cross-section open. As another example, one end of the second area (e.g., an end in the-z direction) may be formed as an open end as the cross-section is open, and the other end of the second area (e.g., an end in the z direction) may be formed as a closed end/short end as the cross-section of the second area is closed by the second surface 221b of the outer conductor 221.

In other words, when viewed in an xz plane, the first area and the second area may each include a closed end/short end and an open end and may be shaped overall in the form of “[”, and based on the above-described structure, the first area and the second area may each function as a resonator with a length of a quarter of the microwave wavelength.

According to an embodiment, the first internal conductor 223 and the second internal conductor 225 are formed to have the same length with respect to the z axis, and thus, the first area and the second area may be symmetrically arranged; however, one or more embodiments are not limited thereto.

The aerosol generating article 10 inserted into the inner space of the outer conductor 221 through the accommodation space 220h may be surrounded by the first internal conductor 223 and the second internal conductor 225 and may be heated by using a dielectric heating method.

At least a portion of the electric field, which is generated in the first area and/or the second area due to microwave resonance, may propagate towards the inside of the first internal conductor 223 and/or the second internal conductor 225 through the gap 226 between the first internal conductor 223 and/or the second internal conductor 225, and the aerosol generating article 10 surrounded by the first internal conductor 223 and the second internal conductor 225 may be heated by the propagating electric field. For example, dielectric materials included in the aerosol generating article 10 may generate heat because of the electric field propagating through the gap 226, and the aerosol generating article 10 may be heated by the heat generated in the dielectric materials.

The heater assembly 200 according to an embodiment may be designed such that the diameters first internal conductor 223 and the second internal conductor 225 may each fall below a designated value, thereby preventing the electric field, which propagates into the first internal conductor 223 and/or the second internal conductor 225, from leaking to the outside of the heater assembly 200 or the resonating unit 220.

In the present specification, the term ‘designated value’ may refer to a diameter value at which the electric field starts leaking to the outside of the first internal conductor 223 and/or the second internal conductor 225. For example, when the diameter of the first internal conductor 223 and/or the second internal conductor 225 has a designated value or more, part of the electric field entering the first internal conductor 223 and/or the second internal conductor 225 may leak to the outside of the resonating unit 220.

On the contrary, the heater assembly 200 according to an embodiment may prevent the electric field from propagating to the outside of the resonating unit 220 according to the structure in which the diameters of the first internal conductor 223 and the second internal conductor 225 are less than the designated value, thereby preventing the electric field from leaking to the outside of the heater assembly 200 or the resonating unit 220 without a separate blocking member.

According to an embodiment, when the aerosol generating article 10 is inserted into the resonating unit 220 through the accommodation space 220h, the tobacco rod 11 of the aerosol generating article 10 may be arranged at a position corresponding to the gap 226 between the first internal conductor 223 and the second internal conductor 225.

As the electric field generated in the first area and the electric field generated in the second area are introduced to the first internal conductor 223 and/or the second internal conductor 225 through the gap 226, the strongest electric field may be generated in a peripheral area of the gap 226 within the inner area of the resonating unit 220.

In the heater assembly 200 according to an embodiment, the tobacco rod 11 including dielectric materials generating heat due to the electric field is arranged at the position corresponding to the gap 226 where the electric field is the strongest, and thus, the heating efficiency (or ‘dielectric heating efficiency’) of the heater assembly 200 may be improved.

According to an embodiment, the resonating unit 220 may further include a closing unit 224 that is located inside the first internal conductor 223, closes a cross-section of the first internal conductor 223, and restricts a flow direction of the aerosol generated from the aerosol generating article 10. For example, the closing unit 224 may block the flow of the aerosol, which is generated from the aerosol generating article 10, in the −z direction by closing the cross-section of the first internal conductor 223.

When the aerosol generated from the aerosol generating article 10 or droplets, which are generated as the aerosol is liquefied, flow in the −z direction and enter other components of the aerosol generating device (e.g., the aerosol generating device 100 of FIG. 1), malfunction or damage to the components of the aerosol generating device may occur. On the contrary, the heater assembly 200 according to an embodiment restricts the flow direction of the aerosol by using the closing unit 224, thereby preventing malfunction or damage to the components of the aerosol generating device that is caused by the aerosol or droplets.

According to an embodiment, the resonating unit 220 may further include the dielectric accommodation space 227 for accommodating dielectric materials. The dielectric accommodation space 227 may refer to an empty space between the outer conductor 221, the first internal conductor 223, and the second internal conductor 225, and dielectric materials with low microwave absorption may be accommodated in the dielectric accommodation space 227. For example, the dielectric material may include at least any one of quartz, tetrafluoroethylene, and aluminum oxide, or a combination thereof, but one or more embodiments are not limited thereto.

In the heater assembly 200 according to an embodiment, the dielectric materials may be arranged in the dielectric accommodation space 227, and thus, an electric field such as the resonating unit 220 without dielectric materials may be generated while reducing the overall size of the resonating unit 220. That is, in the heater assembly 200 according to an embodiment, the size of the resonating unit 220 may be reduced by using the dielectric materials arranged in the dielectric accommodation space 227 to decrease the mounting space required for the resonating unit 220 in the aerosol generating device, resulting in the miniaturization of the aerosol generating device.

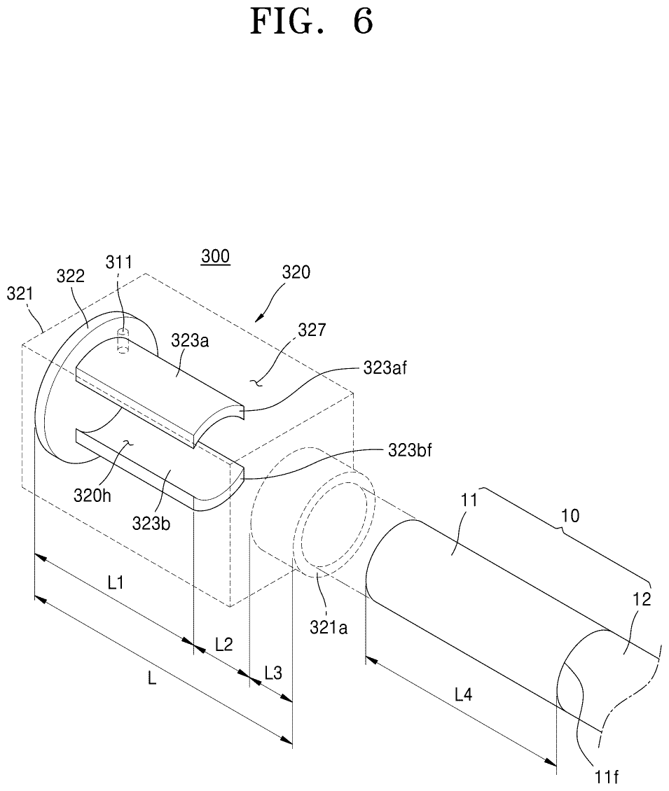

FIG. 6 is a schematic perspective view of a heater assembly according to another embodiment.

A heater assembly 300 shown in the embodiment of FIG. 6 may include a resonating unit 320 that generates microwave resonance and a coupler 311 that supplies microwaves to the resonating unit 320.

The resonating unit 320 may include a case 321, a plurality of plates 323a and 323b, and a connecting portion 322 that connects the case 321 to the plates 323a and 323b.

The coupler 311 may deliver microwaves to at least one of the plates 323a and 323b to generate microwave resonance in the resonating unit 320.

The resonating unit 320 may surround at least a portion of the aerosol generating article 10 inserted into the aerosol generating device. The coupler 311 may provide the resonating unit 320 with the microwaves generated by an oscillating unit (not shown). When the microwaves are supplied to the resonating unit 320, microwave resonance occurs in the resonating unit 320 such that the resonating unit 320 may heat the aerosol generating article 10. For example, the dielectric materials included in the aerosol generating article 10 may generate heat due to the electric field generated within the resonating unit 220 due to the microwaves, and the aerosol generating article 10 may be heated by the heat generated in the dielectric materials.

The case 321 of the resonating unit 320 functions as the ‘outer conductor.’ Because the case 321 has an empty hollow shape, the components of the resonating unit 320 may be arranged within the case 321.

The case 321 may include an accommodation space 320h for accommodating the aerosol generating article 10 and an opening 321a through which the aerosol generating article 10 may be inserted. The opening 321a is connected to the accommodation space 320h. Because the opening 321a is open towards the outside of the case 321, the accommodation space 320h is connected to the outside through the opening 321a. Therefore, the aerosol generating article 10 may be inserted into the accommodation space 320h of the case 321 through the opening 321a of the case 321.

The case 321 in the drawing has a square shape, but the shape may vary. For example, the structure of the case 321 may be modified to have various cross-sectional shapes, for example, a rectangle, an oval, or a circle. The case 321 may extend in a direction.

The plurality of plates 323a and 323b functioning as ‘internal conductors’ of the resonating unit 320 may be arranged inside the case 321.

The plates 323a and 323b may be arranged apart from each other along a circumferential direction of the aerosol generating article 10 accommodated in the accommodation space 320h. The plates 323a and 323b may include a first plate 323a arranged to surround a portion of the aerosol generating article 10 and a second plate 323b arranged to surround another portion of the aerosol generating article 10.

The plates 323a and 323b may be connected to the case 321 via the connecting portion 322. In addition, one end of the first plate 323a of the plates 323a and 323b may be connected to one end of the second plate 323b via the connecting portion 322. Therefore, a closed end/short end may be formed at the one end of each of the plates 323a and 323b by the connecting portion 322.

The other end 323af of the first plate 323a of the plates 323a and 323b and the other end 323bf of the second plate 323b may be spaced apart from each other and thus open. Because other ends of the plates 323a and 323b are spaced apart from each other, open ends may be formed at the other ends of the plates 323a and 323b.

As the plates 323a and 323b are connected to the connecting portion 322, a resonator assembly may be completed. The cross-sectional shape of the resonator assembly taken along a lengthwise direction thereof may include a horseshoe shape.

The plates 323a and 323b extend in the lengthwise direction of the aerosol generating article 10. At least a portion of the plates 323a and 323b may be curved to protrude outward from the center of the aerosol generating article 10 in the lengthwise direction thereof.

For example, when the aerosol generating article 10 has a cylindrical shape, the plates 323a and 323b may be curved in a circumferential direction along the outer circumferential surface of the aerosol generating article 10. The radius of curvature of the cross-section of the plates 323a and 323b may be identical to that of the aerosol generating article 10. The radius of curvature of the cross-section of the plates 323a and 323b may be variously modified. For example, the radius of curvature of the cross-section of the plates 323a and 323b may be greater or less than that of the aerosol generating article 10.

According to the structure in which the plates 323a and 323b are curved in the circumferential direction along the outer circumferential surface of the aerosol generating article 10, a more uniform electric field may be formed in the resonating unit 320, and thus, the heater assembly 300 may uniformly heat the aerosol generating article 10.

The open ends at the other ends of the plates 323a and 323b may face the opening 321a of the case 321. The opening 321a of the case 321 may be arranged away from the other ends of the plates 323a and 323b.

The open ends at the other ends of the plates 323a and 323b may be aligned with the opening 321a of the case 321. Therefore, when the aerosol generating article 10 is inserted through the opening 321a of the case 321 and placed in the accommodation space 320h, a portion of the aerosol generating article 10 located in the accommodation space 320h may be surrounded by the plates 323a and 323b.

Two plates, that is, the plates 323a and 323b, may be arranged at opposite locations with respect to the center of the aerosol generating article 10 in the lengthwise direction thereof. One or more embodiments are not limited by the number of plates 323a and 323b, and the number of plates 323a and 323b may be, for example, three or at least four.

The plates 323a and 323b may be arranged symmetrically to each other with respect to the lengthwise direction of the aerosol generating article 10, that is, the central axis in the extension direction of the aerosol generating article 10.

At least one of the plates 323a and 323b may contact the coupler 311 connected to the oscillating unit (not shown). In detail, at least a portion of the first plate 323a may contact the coupler 311. When microwaves are delivered to the first plate 323a through the coupler 311, microwave resonance is formed between the plates 323a and 323b. In addition, microwave resonance is formed not only between the first plate 323a and an upper side plate of the case 321 but also between the second plate 323b and a lower side plate of the case 321. Therefore, electric fields may be generated respectively between the plates 323a and 323b and the connecting portion 322, between the first plate 323a and the upper side plate of the case 321, and between the second plate 323b and the lower side plate of the case 321.

As the coupler 311 penetrates the case 321, one end of the coupler 311 may contact the oscillating unit (not shown), and the other end thereof may contact a portion of the first plate 323a. As the microwaves generated from the oscillating unit (not shown) are delivered to the plates 323a and 323b and the connecting portion 322 through the coupler 311, an electric field may be generated inside the assembly of the plates 323a and 323b and the connecting portion 322.

In addition, according to the structure of the resonating unit 320 of the heater assembly 300, a triple resonance mode may be formed in the resonating unit 320. Resonance of the transverse electric and magnetic (TEM) mode of microwaves is formed between the plates 323a and 323b. Additionally, the resonance of the TEM mode, which is different from the resonance formed between the plates 323a and 323b, is generated not only between the first plate 323a and the upper side plate of the case 321 but also between the second plate 323b and the lower side plate of the case 321. Because the resonating unit 320 of FIG. 6 may resonate in the TEM mode by using the plates 323a and 323b, the resonating unit 320 of FIG. 6 may be smaller in size than the resonating unit 220 of FIG. 5 that may only resonate in the transverse electric (TE) and transverse magnetic (TM) modes.

As triple resonance occurs in the resonating unit 320 of the heater assembly 300, the aerosol generating article 10 may be more effectively and uniformly heated.

The resonating unit 320 according to the embodiment may include a closed end/short end, in which a cross-section is closed to have a length of one quarter (λ/4) of the wavelength (λ) of the microwaves, and an open end, in which at least a portion of the cross-section is open.

A region at one end of the resonating unit 320, which corresponds to the region on the left side in FIG. 6, forms a closed closed end/short end due to the structure in which the connecting portion 322 and the ends of the plates 323a and 323b are connected to the case 321. A region at the other end of the resonating unit 320, which corresponds to the region on the right side in FIG. 6, forms an open end as the opening 321a of the case 321 is exposed to the outside. With the above structure of the resonating unit 320, the resonating unit 320 may function as a resonator with a length of one quarter of the wavelength of the microwaves.

According to the above-described resonance structure of the resonating unit 320, an electric field may not propagate to the outer region of the resonating unit 320. Therefore, the heater assembly 300 may prevent the electric field from leaking to the outside of the heater assembly 300 without a separate blocking member for blocking the electric field.

The aerosol generating article 10 inserted into the accommodation space 320h of the case 321 may be surrounded by the first plate 323a and the second plate 323b and thus heated using a dielectric heating method. For example, a portion including a medium of the aerosol generating article 10 inserted into the accommodation space 320h of the case 321 may be located in the space between the first plate 323a and the second plate 323b. As dielectric materials included in the aerosol generating article 10 generate heat because of the electric field formed in the space between the first plate 323a and the second plate 323b, the aerosol generating article 10 may be heated.

In addition, secondary heating on the aerosol generating article 10 may occur due to the action of the electric field resulting from the resonance modes respectively formed between the first plate 323a and the upper side plate of the case 321 and between the second plate 323b and the lower side plate of the case 321.

When the aerosol generating article 10 is inserted into the resonating unit 320 through the accommodation space 320h, a tobacco rod 11 of the aerosol generating article 10 may be located between the plates 323a and 323b.

A length L4 of the tobacco rod 11 may be greater than a length L1 of the plates 323a and 323b. Therefore, a front end 11f of the tobacco rod 11 contacting a filter rod 12 protrudes more in a direction towards the opening 321a of the case 321, compared to the other end 323af of the first plate 323a and the other end 323bf of the second plate 323b.

Resonance peaks are formed at the other ends of the plates 323a and 323b operating as the resonators, allowing for the generation of a stronger electric field at the other ends than in other regions. When the aerosol generating article 10 is inserted into the heater assembly 300, the tobacco rod 11 including the dielectric materials capable of generating heat by the electric field is arranged to correspond to the region where the electric field is the strongest, and thus the heating efficiency (or the ‘dielectric heating efficiency’) of the heater assembly 300 may be improved.

Referring to FIG. 6, the length L1 of the plates 323a and 323b may be set to be less than the length L1+L2 of the inner space of the case 321. Therefore, the other ends of the plates 323a and 323b may be arranged on the inner side of the case 321 compared to the opening 321a. In other words, the other ends of the plates 323a and 323b may be spaced apart from the rear end of the opening 321a by a length of L2.

The length from the rear end of the opening 321a, where the opening 321a is connected to the case 321, to the front end of the opening 321a, where the opening 321a is open, may be L3. The total length of the case 321 along the lengthwise direction of the case 321 may be L. The total length L of the case 321 may be determined by the sum of the length L1 of the plates 323a and 323b, the length L2 between the plates 323a and 323b and the rear end of the opening 321a, and the length L3 where the opening 321a protrudes from the case 321.

To prevent the microwave leakage, the front end of the opening 321a, where the opening 321a is open, protrudes from the case 321 by a length of L3. As the opening 321a of the case 321 protrudes from the case 321, the opening 321a may prevent the microwaves in the case 321 of the resonating unit 320 from leaking to the outside of the case 321.

The resonating unit 320 may further include a dielectric accommodation space 327 for accommodating dielectric materials. The dielectric accommodation space 327 may be formed in the empty space between the case 321 and the plates 323a and 323b. In the dielectric accommodation space 327, dielectric materials with low microwave absorption may be accommodated.

As the dielectric materials are arranged within the dielectric accommodation space, the heater assembly 300 may generate an electric field, which is similar to an electric field produced by a resonating unit with no dielectric materials, may be generated while reducing the overall size of the resonating unit 320. In other words, the mounting space for the resonating unit 320 in the aerosol generating device may decrease by reducing the size of the resonating unit 320 by using the dielectric materials arranged within the dielectric accommodation space 327, leading to the miniaturization of the aerosol generating device.

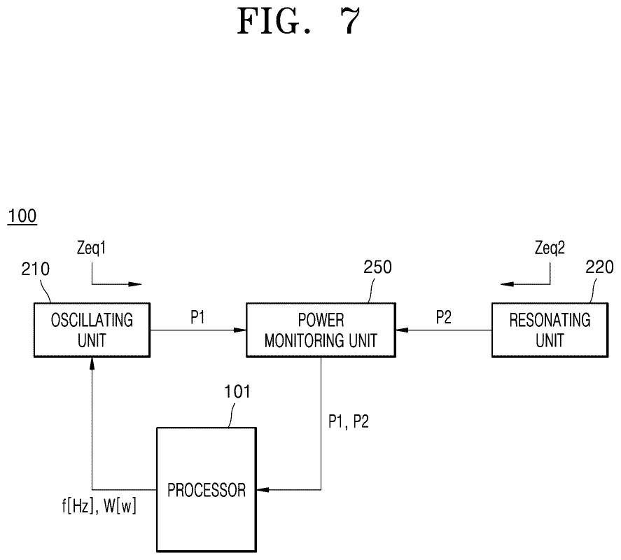

FIG. 7 is an internal block diagram for explaining an output control method of an oscillating unit, according to an embodiment.

In more detail, FIG. 7 only shows components for controlling the output of the oscillating unit 210 among the components of the aerosol generating device 100 shown in FIGS. 3 and 4. The output from the oscillating unit 210 may refer to the magnitude and frequency of the microwave power; thus, the descriptions already provided with reference to FIGS. 3 and 4 are omitted.

Referring to FIG. 7, the aerosol generating device 100 may include the oscillating unit 210, the power monitoring unit 250, the resonating unit 220, and the processor 101.

The oscillating unit 210 may output microwaves with a preset output frequency and preset amount of power under the control by the processor 101.

The oscillating unit 210 may include at least one switching device, and the processor 101 may vary the output frequency of the microwaves by adjusting turning on/off of the switching device. For example, the processor 101 may control the oscillating unit 210 to output microwaves with any one output frequency selected from the range from 2.4 Ghz to 2.5 Ghz or the range from 5.7 Ghz to 5.9 Ghz.

In addition, the oscillating unit 210 may include a power amplifier, and the power amplifier may increase or decrease the amplitude of microwaves and thus adjust the power magnitude of the output microwaves under the control by the processor 101. For example, the processor 101 may control the oscillating unit 210 and output microwaves with at least one power magnitude selected from the range from 3 W to 20 W.

The microwaves output from the oscillating unit 210 may be output to the resonating unit 220.

The resonating unit 220 may accommodate the aerosol generating article 10 and resonate the microwaves provided from the oscillating unit 210, thus heating the aerosol generating article 10. The internal structure of the resonating unit 220 may be the same as those shown in FIGS. 4 to 6.

The power monitoring unit 250 may be provided to track the change in the resonance frequency of the resonating unit 220 in real time.

In more detail, as the dielectric materials included in the aerosol generating article 10 are heated by microwaves and exhausted, the impedance of the resonating unit 220 may vary. When the oscillating unit 210 is controlled at a fixed output even though the impedance of the resonating unit 220 varies, a first impedance Zeq1 from the oscillating unit 210 to the resonating unit 220 may not match a second impedance Zeq2 from the resonating unit 220 to the oscillating unit 210. In other words, the first impedance Zeq1 may not match the second impedance Zeq2. In addition, because impedance matching is related to maximum power transmission conditions, the maximum power transmission conditions may not be satisfied. Accordingly, the power supplied from the oscillating unit 210 may not be fully transmitted to the resonating unit 220, and part of the power may be reflected from the resonating unit 220 and input back towards the oscillating unit 210.

To match the first impedance Zeq1 with the second impedance Zeq2, the power monitoring unit 250 may measure the reflected microwave power that is reflected from the resonating unit 220 and input to the oscillating unit 210. According to an embodiment, the power monitoring unit 250 may additionally measure output microwave power that is output from the oscillating unit 210 and input to the resonating unit 220. Hereinafter, the output microwave power may be referred to as first power P1, and the reflected microwave power may be referred to as second power P2. The first power P1 and the second power P2 may refer to magnitudes of power.

The power monitoring unit 250 may provide the processor 101 with information regarding the first power P1 and/or the second power P2.

The processor 101 may match the first impedance Zeq1 with the second impedance Zeq2 based on the information regarding the first power P1 and/or the second power P2, the information being provided from the power monitoring unit 250. The impedance matching may be achieved by adjusting the output frequency of the oscillating unit 210. It is because the impedance is a parameter related to the frequency.

The processor 101 may adjust the output frequency of the oscillating unit 210 to ensure that the second power P2 measured by the power monitoring unit 250 is included in the reference power range. According to an embodiment, the processor 101 may adjust the output frequency of the oscillating unit 210 to ensure that the difference between the first power P1 and the second power P2 falls within the preset reference power range, wherein the difference is measured by the power monitoring unit 250. For example, the reference power range may be between 0 w and 1 w, but is not limited thereto.

The processor 101 may control the oscillating unit 210 such that the output frequency from the oscillating unit 210 is swept within the preset frequency range and the second power P2 is included in the reference power range. According to an embodiment, the processor 101 may control the oscillating unit 210 to ensure that the difference between the first power P1 and the second power P2 falls within the preset range. For example, the reference frequency range may be from 2.4 Ghz to 2.5 Ghz or from 5.7 Ghz to 5.9 Ghz, but is not limited thereto.

The adjustment of the output frequency by the processor 101 described above may be performed in real time. In other words, the processor 101 may adjust the output frequency of the oscillating unit 210, independently of the adjustment of the power magnitude of the oscillating unit 210 described below.

The processor 101 may adjust the magnitude of the microwave power that is output from the oscillating unit 210 according to a preset temperature profile and/or power profile, regardless of the adjustment of the output frequency of the oscillating unit 210.

The temperature profile may include information regarding a target temperature of the aerosol generating article 10 over time. In addition, the power profile may include information regarding target power of the oscillating unit 210 over time. In other words, the temperature profile and power profile may respectively include information regarding the target temperature and target power for the preheating section and the smoking section.

The processor 101 may control the oscillating unit 210 and output microwave power at a first power level in the preheating section. Additionally, the processor 101 may control the oscillating unit 210 and output microwave power at a second power level in the smoking section after the preheating section, wherein the second power level is lower than the first power level. Moreover, the processor 101 may progressively increase the magnitude of the microwave power in the smoking section.

The processor 101 may match the output frequency of the oscillating unit 210 with the resonance frequency of the resonating unit 220 in real time while the magnitude of the microwave power output from the oscillating unit 210 is adjusted according to a preset profile. As the output frequency of the oscillating unit 210 aligns with the resonance frequency of the resonating unit 220, the power transmission efficiency may significantly increase, and the aerosol generating article 10 may be uniformly heated.

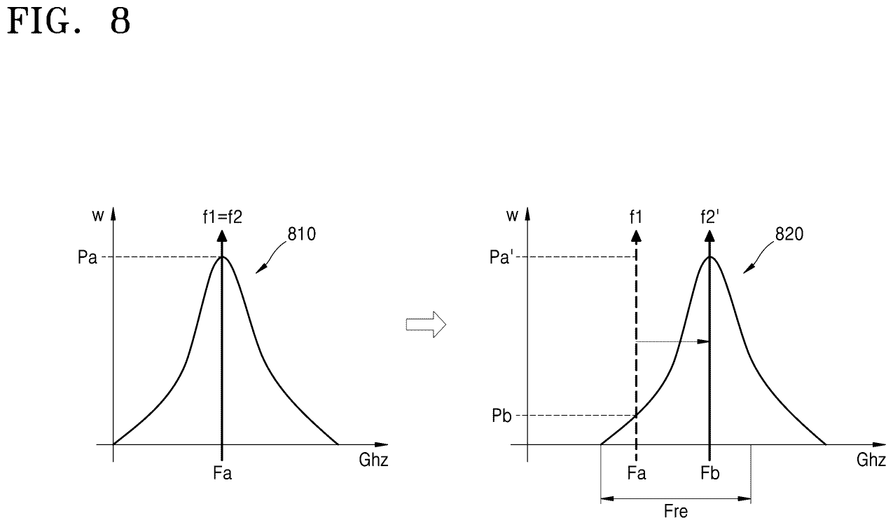

FIG. 8 is a diagram showing a method of tracking a resonance frequency by using output microwave power of an oscillating unit and reflected microwave power of a resonating unit.

Referring to FIG. 8, the processor 101 may detect mismatching between the first impedance Zeq1 and the second impedance Zeq2 based on the difference between the first power P1 and/or the second power P2 and may adjust the output frequency of the oscillating unit 210 to match the impedances. Upon adjusting the output frequency, the output frequency may match the resonance frequency of the resonating unit 220. The matching stated in the specification includes not only complete matching but also matching when an output frequency falls within the range defined by an upper limit of the resonance frequency and a lower limit thereof. Such a range is configured to consider losses by internal components of the dielectric heating unit 200. For example, matching refers to a case where the output frequency falls within the range from the resonance frequency−α to the resonance frequency+α, wherein a may be 10 khz. However, one or more embodiments are not limited thereto.

In FIG. 8, the x axis represents the frequency, and the y axis represents the amount of power transmitted to the resonating unit 220 according to the frequency. FIG. 8 shows a graph 810 illustrating when the output frequency of the oscillating unit 210, f1, matches the resonance frequency of the resonating unit 220, f2, and a graph 820 illustrating when the resonance frequency of the resonating unit 220 is varied to f2′ and the output frequency f1 of the oscillating unit 210 aligns with the changed resonance frequency f2′ of the resonating unit 220.

In FIG. 8, the output frequency f1 of the oscillating unit 210 may match the resonance frequency f2 of the resonating unit 220. For example, when receiving a user input for heating a device, the processor 101 may sweep the output frequency of the oscillating unit 210 and may select a frequency Fa, at which the second power P2 reflected from the resonating unit 220 and input to the oscillating unit 210 is minimized, as the output frequency. According to an embodiment, the processor 101 may select, as the output frequency, the frequency Fa at which the difference between the first power P1 transmitted from the oscillating unit 210 to the resonating unit 220 and the second power P2 reflected from the resonating unit 220 and input to the oscillating unit 210 is minimized. As the output frequency f1 of the oscillating unit 210 matches the resonance frequency f2 of the resonating unit 220, the maximum power Pa may be supplied to the resonating unit 220. The resonating unit 220 may use the power supplied from the oscillating unit 210, thus heating the aerosol generating article 10.

As the dielectric material included in the aerosol generating article 10 is heated by microwaves and depleted, the impedance of the resonating unit 220 may vary, and the resonance frequency f2 may change accordingly. In an embodiment, the resonance frequency f2 of the resonating unit 220 may increase to f2′ according to the decrease in the dielectric material included in the aerosol generating article 10. When the oscillating unit 210 is controlled with a fixed output frequency despite the increase in the resonance frequency of the resonating unit 220 to f2′, the maximum power Pa′ may not be transmitted to the resonating unit 220, and power, which is equal to Pb of less than Pa′, may be delivered to the resonating unit 220. In other words, the resonating unit 220 may consume the power by as much as Pb, and the remaining power may be reflected and output towards the oscillating unit 210.

The processor 101 may match the output frequency f1 of the oscillating unit 210 with the varied resonance frequency f2′, thus adjusting the output frequency f1 to ensure that the maximum power is transmitted to the resonating unit 220. To this end, the processor 101 may receive, from the power monitoring unit 250, information regarding the first power P1 that is output from the oscillating unit 210 to the resonating unit 220. In addition, the processor 101 may receive information regarding the second power P2 that is reflected from the resonating unit 220 and input towards the oscillating unit 210. The processor 101 may receive, from the power monitoring unit 250, information regarding the second power P2 corresponding to the change in the resonance frequency of the resonating unit 220 in real time.

The processor 101 may control the oscillating unit 210 to ensure that the second power P2 measured by the power monitoring unit 250 falls within the reference power range. According to an embodiment, the processor 101 may control the output of the oscillating unit 210 to ensure that the difference between the first power P1 and the second power P2 falls within the preset reference power range, wherein the difference is measured by the power monitoring unit 250. For example, the reference power range may be between 0 w and 1 w, but is not limited thereto.

The processor 101 may control the oscillating unit 210 to sweep the frequency of the microwave power that is output from the oscillating unit 210 within a preset reference frequency range Fre and ensure that the second power P2 falls within the reference power range. According to an embodiment, the processor 101 may adjust the output frequency of the microwave power to make the difference between the first power P1 and the second power P2 fall within the reference power range. For example, the reference frequency range Fre may be from 2.4 Ghz to 2.5 Ghz or from 5.7 Ghz to 5.9 Ghz, but is not limited thereto.

The processor 101 may adjust the output frequency of the microwave power to any one frequency selected from the reference frequency range Fre to ensure that the difference between the first power P1 and the second power P2 falls within the reference power range, thereby matching the output frequency with the resonance frequency. In other words, the processor 101 may adjust the output frequency of the oscillating unit 210 from Fa to Fb that is the resonance frequency of the resonating unit 220. The adjustment of the output frequency of the microwave power described above may be performed regardless of the magnitude of the microwave power.

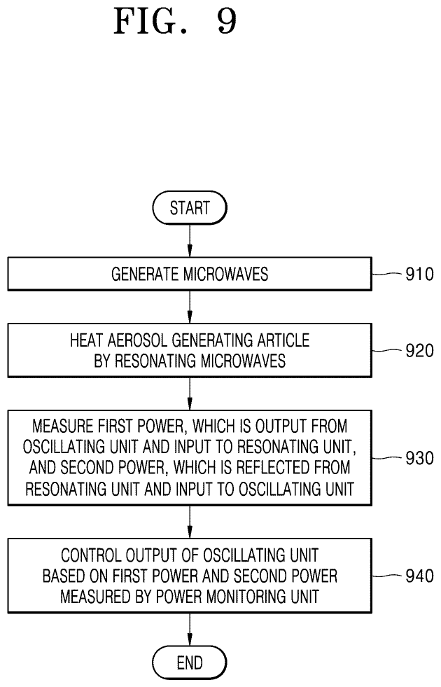

FIG. 9 is a flowchart of a method of operating an aerosol generating device according to an embodiment.

Referring to FIG. 9, in operation S910, the oscillating unit 210 may generate microwaves.

The oscillating unit 210 may include a solid-state-based RF generating device and generate microwaves by using the same.

The oscillating unit 210 may output microwaves with a preset output frequency and preset amount of power under the control by the processor 101.

The oscillating unit 210 may include at least one switching device, and the processor 101 may vary the output frequency of the microwaves by adjusting turning on/off of the switching device. For example, the processor 101 may control the oscillating unit 210 to output microwaves with any one output frequency selected from the range from 2.4 Ghz to 2.5 Ghz or the range from 5.7 Ghz to 5.9 Ghz.

In operation S920, the resonating unit may accommodate the aerosol generating article 10 and resonate the microwaves, thus heating the aerosol generating article 10.

As shown in FIG. 5, the resonating unit 220 may include the first internal conductor 223, which has a hollow cylinder shape surrounding a portion of the aerosol generating article 10, and the second internal conductor 225 which is spaced apart from the first internal conductor 223 by a certain distance and has a hollow cylinder shape surrounding another portion of the aerosol generating article 10. Microwaves may resonate between the outer conductor 221 and each of the first internal conductor 223 and the second internal conductor 225 by the first internal conductor 223 and the second internal conductor 225, and the electric field according to the microwave resonance may heat the aerosol generating article 10.

As shown in FIG. 6, the resonating unit 220 may include the first plate 323a that surrounds a portion of the aerosol generating article 10, and the second plate 323b that is spaced apart from the first plate 323a along the circumferential direction of the aerosol generating article 10 and surrounds another portion of the aerosol generating article 10. Microwaves may resonate (so called, a triple resonance structure) between the first plate 323a and the second plate 323b, between the case 321 and each of the first plate 323a and the second plate 323b because of the first plate 323a and the second plate 323b, and the electric field according to the microwave resonance may heat the aerosol generating article 10.

In operation S930, the power monitoring unit 250 may measure the first power P1, which is output from the oscillating unit 210 and input to the resonating unit 220, and the second power P2, which is reflected from the resonating unit 220 and input towards the oscillating unit 210. According to an embodiment, the power monitoring unit 250 may only measure the second power P2 and continue to perform subsequent operations.

The resonance frequency of the resonating unit 220 may vary as the dielectric material included in the aerosol generating article 10 is heated by the microwaves and depleted. When the resonance frequency of the resonating unit 220 varies, the maximum power of the oscillating unit 210 may not be supplied to the resonating unit 220, and the power monitoring unit 250 is configured to detect the frequency mismatching based on the second power P2 or the difference between the first power P1 and the second power P2 and provide the information regarding the first power P1 and/or the second power P2 to the processor 101.

In operation S940, the processor 101 may control the output of the oscillating unit 210 based on the first power P1 and the second power P2 that are measured by the power monitoring unit 250. According to an embodiment, the processor 101 may control the output of the oscillating unit 210 based only on the second power P2 measured by the power monitoring unit 250.

The processor 101 may adjust the output frequency of the oscillating unit 210 to ensure that the second power P2 measured by the power monitoring unit 250 falls within the reference power range. According to an embodiment, the processor 101 may control the output of the oscillating unit 210 to ensure that the difference between the first power P1 and the second power P2 falls within the preset reference power range, wherein the difference is measured by the power monitoring unit 250. In this case, the output of the oscillating unit 210 may refer to the output frequency of the microwave power.

The processor 101 may control the oscillating unit 210 to sweep the output frequency of the microwave power that is output from the oscillating unit 210 within the preset reference frequency range and ensure that the second power P2 falls within the reference power range. According to an embodiment, the processor 101 may adjust the output frequency of the microwave power to ensure that the difference between the first power P1 and the second power P2 falls within the reference power range.

The processor 101 may adjust the output frequency of the microwave power by using any one frequency selected from the reference frequency range, thus matching the output frequency with the resonance frequency.

The processor 101 may control the magnitude of the microwave power independently from the output frequency of the microwave power.

Any embodiments of the present disclosure or other embodiments described above are not mutually exclusive or distinct from each other. Any embodiment or other embodiments described in this disclosure may be combined with one another, both in terms of configurations and functions.

For example, configuration A from a specific embodiment and/or drawing can be combined with configuration B from another embodiment and/or drawing. This means that even if a combination of components is not explicitly described, such combinations are still possible unless specifically stated otherwise.

The detailed description above should not be interpreted as limiting in any respect, but rather as illustrative. The scope of the present disclosure should be defined by a reasonable interpretation of the appended claims, and all modifications that fall within the equivalent scope of the present disclosure are included in its scope.

1. An aerosol generating device comprising:
an oscillating unit configured to generate microwaves;
a resonating unit configured to accommodate an aerosol generating article and heat the aerosol generating article by resonating the microwaves;
a power monitoring unit configured to measure reflected microwave power that is reflected from the resonating unit and input to the oscillating unit; and
a processor configured to control an output of the oscillating unit based on the reflected microwave power measured by the power monitoring unit.

2. The aerosol generating device of claim 1, wherein, in the resonating unit, a resonance frequency of the microwaves varies as a dielectric material in the aerosol generating article is heated by the microwaves and consumed.

3. The aerosol generating device of claim 2, wherein a resonance frequency of the resonating unit increases as the dielectric material in the aerosol generating article is consumed.

4. The aerosol generating device of claim 2, wherein the power monitoring unit is further configured to measure the reflected microwave power corresponding to a change in the resonance frequency.

5. The aerosol generating device of claim 1, wherein the processor is further configured to control an output of the oscillating unit so that the reflected microwave power measured by the power monitoring unit is included in a preset reference power range.

6. The aerosol generating device of claim 5, wherein the processor is further configured to sweep the output frequency of the microwave power output from the oscillating unit within the preset reference frequency range and adjust the output frequency of the microwave power so that the reflected microwave power is included in the reference power range.

7. The aerosol generating device of claim 6, wherein the processor is further configured to sweep the output frequency of the microwave power output from the oscillating unit within the reference frequency range from about 2.4 Ghz to about 2.5 Ghz.

8. The aerosol generating device of claim 6, wherein the processor is further configured to match the output frequency with a resonance frequency of the resonating unit by adjusting the output frequency of the microwave power with any one frequency selected from the reference frequency range.

9. The aerosol generating device of claim 1, wherein the processor is further configured to adjust a magnitude of microwave power that is output from the oscillating unit and independently control the magnitude of the microwave power and the output frequency of the microwave power according to a preset power profile.

10. The aerosol generating device of claim 1, wherein the resonating unit comprises a first internal conductor with a hollow cylinder shape surrounding a portion of the aerosol generating article and a second internal conductor arranged apart from the first internal conductor by a certain distance and having a hollow cylinder shape surrounding another portion of the aerosol generating article, and
the microwaves resonate between the first internal conductor and the second internal conductor.

11. The aerosol generating device of claim 1, wherein the resonating unit comprises a first plate surrounding a portion of the aerosol generating article and a second plate spaced apart from the first plate along a circumferential direction of the aerosol generating article and surrounding another portion of the aerosol generating article, and
the microwaves resonate between the first plate and the second plate.
